(19) United States
(12) Patent Application Publication
(10) Pub. No.: US 2018/0171616 A1
(43) Pub. Date: Jun. 21, 2018

(54) Sewage Control System

(71) Applicant: Keith Singbeil, Sioux Lookout (CA)

(72) Inventor: Keith Singbeil, Sioux Lookout (CA)

(21) Appl. No.: 15/379,977

(22) Filed: Dec. 15, 2016

(51) Int. Cl. E03D 11/17; F16K 15/03

(52) U.S. Cl. CPC E03D 11/17; F16K 15/033

(57) ABSTRACT

A sewage control system for protecting a building from sewage damage includes a building that has a sewage outlet. A toilet is fluidly coupled to the sewage outlet to facilitate defecation and urination in the building. A backflow unit is fluidly coupled to the toilet and the backflow unit is in fluid communication with the sewage outlet. The backflow unit inhibits sewage from flowing into the toilet from the sewage outlet thereby inhibiting the building from being damaged by the sewage.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to sewage devices and more particularly pertains to a new sewage device for protecting a building from sewage damage.

### BRIEF SUMMARY OF THE INVENTION

An embodiment of the disclosure meets the needs presented above by generally comprising a building that has a sewage outlet. A toilet is fluidly coupled to the sewage outlet to facilitate defecation and urination in the building. A backflow unit is fluidly coupled to the toilet and the backflow unit is in fluid communication with the sewage outlet. The backflow unit inhibits sewage from flowing into the toilet from the sewage outlet thereby inhibiting the building from being damaged by the sewage.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a back perspective view of a sewage control system according to an embodiment of the disclosure.

FIG. 2 is a perspective cut-away view of backflow unit of an embodiment of the disclosure.

FIG. 3 is a cross sectional view taken along line 3-3 of FIG. 2 of an embodiment of the disclosure.

FIG. 4 is a cross sectional view taken along line 4-4 of FIG. 1 of an embodiment of the disclosure.

### DETAILED DESCRIPTION OF THE INVENTION

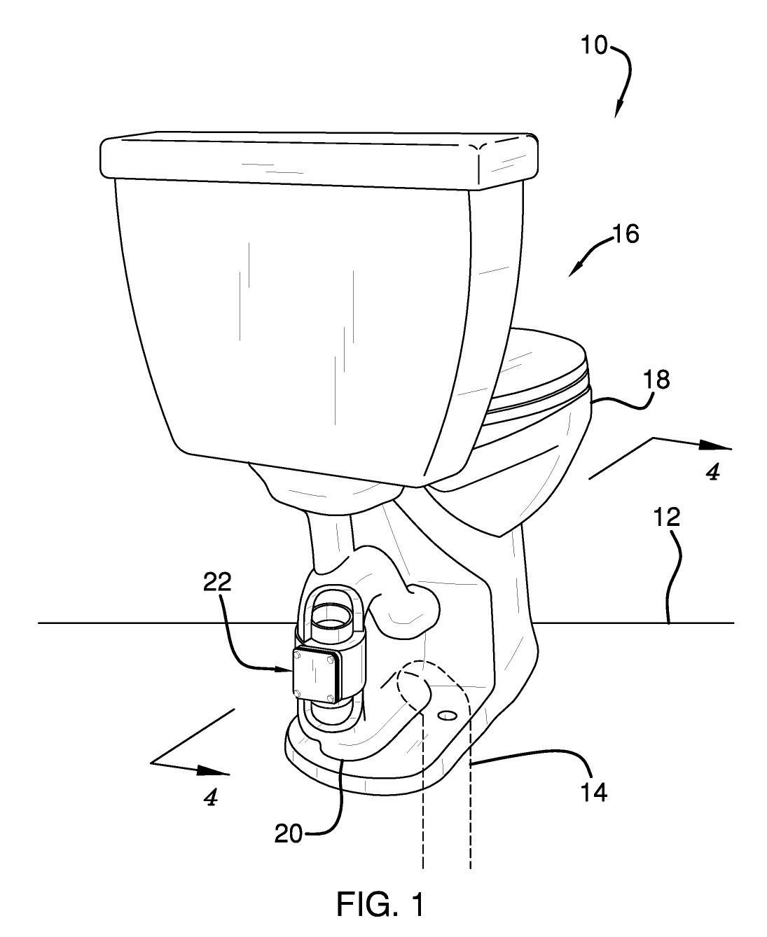

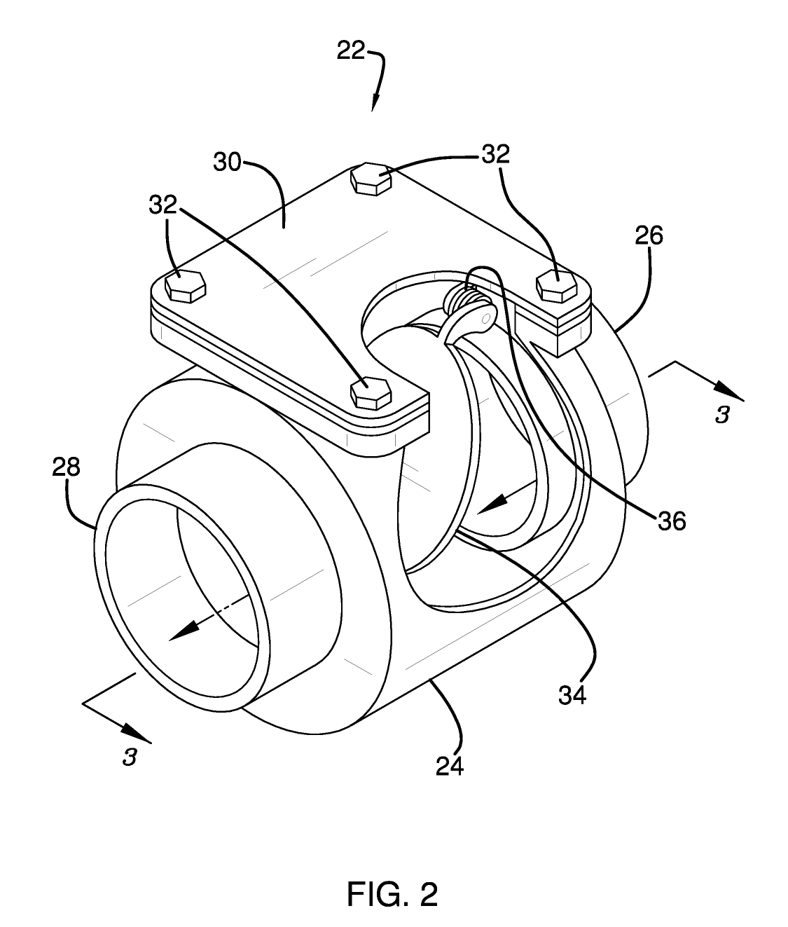

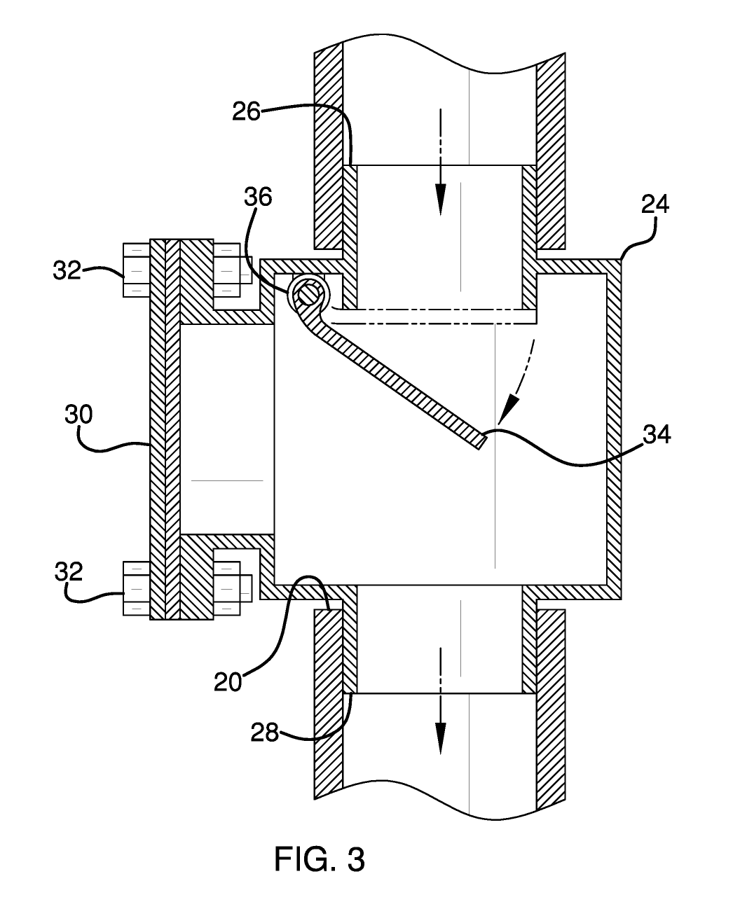

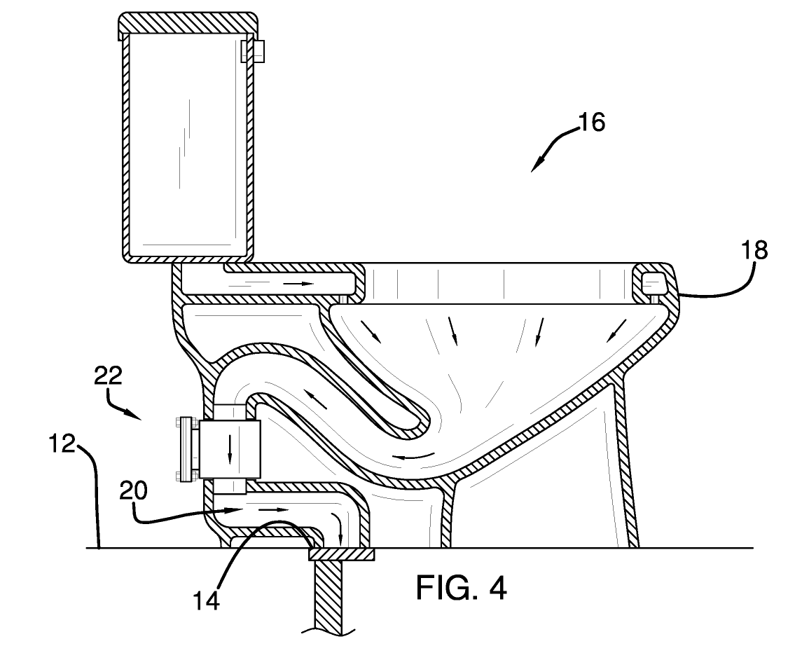

With reference now to the drawings, and in particular to FIGS. 1 through 4 thereof, a new sewage device embodying the principles and concepts of an embodiment of the disclosure and generally designated by the reference numeral 10 will be described.

As best illustrated in FIGS. 1 through 4, the sewage control system 10 generally comprises a building 12 that has a sewage outlet 14. The building 12 may be a house, an office building 12 or any building 12 that has a plumbed bathroom. The sewage outlet 14 may be plumbed to a municipal sewage system, a septic tank or any other conventional means of sewage treatment. A toilet 16 is provided and the toilet 16 is fluidly coupled to the sewage outlet 14 to facilitate defecation and urination in the building 12. The toilet 16 has a bowl 18 and an outlet 20 that is in fluid communication with the bowl 18. The outlet 20 is fluidly coupled to the sewage outlet 14 such that the bowl 18 is in fluid communication with the sewage outlet 14. The toilet 16 may be a two piece residential toilet, a tankless commercial toilet or any other toilet plumbed to a sewage outlet 14.

A backflow unit 22 is provided and the backflow unit 22 is fluidly coupled to the toilet 16. The backflow unit 22 is in fluid communication with the sewage outlet 14 to inhibit sewage from flowing into the toilet 16 from the sewage outlet 14. In this way the backflow unit 22 inhibits the building 12 from being damaged by sewage that backflows out of the toilet 16.

The backflow unit 22 comprises a housing 24 that has an intake 26 and an exhaust 28. The housing 24 is substantially hollow and each of the intake 26 and the exhaust 28 is in fluid communication with an interior of the housing 24. The housing 24 is coupled to the toilet 16 having the exhaust 28 being in fluid communication with the sewage outlet 14. Additionally, the intake 26 is in fluid communication with the bowl 18 to pass waste from the bowl 18 into the sewage outlet 14 when the toilet 16 is flushed.

The housing 24 may be an integral component of the toilet 16. A plate 30 is removably coupled to the housing 24 to access the interior of the housing 24. The plate 30 forms a fluid impermeable seal through a gasket or the like and a plurality of fasteners 32 retains the plate 30 on the housing 24. Each of the fasteners 32 may be a bolt or the like.

A valve 34 is provided and the valve 34 is hingedly coupled to the housing 24. The valve 34 is positioned within the interior of the housing 24. The valve 34 is selectively positioned in a closed position having the valve 34 abutting the intake 26 and forming a fluid impermeable seal with the intake 26. In this way the valve 34 inhibits the sewage from entering the intake 26. The valve 34 is selectively urged into an open position when the toilet 16 is flushed to pass the waste to the sewage outlet 14. A biasing member 36 is coupled between the housing 24 and the valve 34 and the biasing member 36 biases the valve 34 into the closed position. The biasing member 36 may be a spring or the like. The valve 34 may be a disk or the like.

In use, the toilet 16 is installed in the building 12 during new construction or to replace an existing toilet 16 in the building 12. The biasing member 36 biases the valve 34 into the closed position thereby inhibiting sewage from back flowing through the toilet 16. In this way the toilet 16 protects the building 12 from damage resulting from sewage backflow. Water from the bowl 18 urges the valve 34 into the open position when the toilet 16 it flushed. Thus, the valve 34 passes the waste into the sewage outlet 14.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A sewage control system comprising:
a building having a sewage outlet;
a toilet being fluidly coupled to said sewage outlet wherein said toilet is configured to facilitate defecation and urination in said building; and
a backflow unit being fluidly coupled to said toilet, said backflow unit being in fluid communication with said sewage outlet wherein said backflow unit is configured to inhibit sewage from flowing into said toilet from said sewage outlet thereby inhibiting said building from being damaged by the sewage, said backflow unit including a housing having an intake and an exhaust, said housing being substantially hollow, each of said intake and said exhaust being in fluid communication with an interior of said housing, said backflow unit including a plate removably coupled to said housing, said plate covering an opening into said housing wherein removal of said plate provides access to said interior of said housing.

2. The system according to claim 1, wherein said toilet has a bowl and an outlet being in fluid communication with said bowl, said outlet being fluidly coupled to said sewage outlet such that said bowl is in fluid communication with said sewage outlet.

3. (canceled)

4. The system according to claim 1, wherein:
said toilet has a bowl; and
said housing is coupled to said toilet having said exhaust being in fluid communication with said sewage outlet and having said intake being in fluid communication with said bowl wherein said housing is configured to pass waste from said bowl into said sewage outlet when said toilet is flushed.

5. The system according to claim 4, further comprising a valve being hingedly coupled to said housing, said valve being positioned within said interior of said housing, said valve being selectively positioned in a closed position having said valve abutting said intake wherein said valve is configured to inhibit the sewage from entering said intake, said valve being selectively urged into an open position when said toilet is flushed wherein said valve is configured to pass the waste to said sewage outlet.

6. The system according to claim 5, further comprising a biasing member being coupled between said housing and said valve, said biasing member biasing said valve into said closed position.

7. A sewage control system comprising:
a building having a sewage outlet;
a toilet being fluidly coupled to said sewage outlet wherein said toilet is configured to facilitate defecation and urination in said building, said toilet having a bowl and an outlet being in fluid communication with said bowl, said outlet being fluidly coupled to said sewage outlet such that said bowl is in fluid communication with said sewage outlet; and
a backflow unit being fluidly coupled to said toilet, said backflow unit being in fluid communication with said sewage outlet wherein said backflow unit is configured to inhibit sewage from flowing into said toilet from said sewage outlet thereby inhibiting said building from being damaged by the sewage, said backflow unit comprising:
a housing having an intake and an exhaust, said housing being substantially hollow, each of said intake and said exhaust being in fluid communication with an interior of said housing, said housing being coupled to said toilet having said exhaust being in fluid communication with said sewage outlet and having said intake being in fluid communication with said bowl wherein said housing is configured to pass waste from said bowl into said sewage outlet when said toilet is flushed,
a plate removably coupled to said housing, said plate covering an opening into said housing wherein removal of said plate provides access to said interior of said housing,
a valve being hingedly coupled to said housing, said valve being positioned within said interior of said housing, said valve being selectively positioned in a closed position having said valve abutting said intake wherein said valve is configured to inhibit the sewage from entering said intake, said valve being selectively urged into an open position when said toilet is flushed wherein said valve is configured to pass the waste to said sewage outlet, and
a biasing member being coupled between said housing and said valve, said biasing member biasing said valve into said closed position.
